(19) United States
(12) Patent Application Publication
(10) Pub. No.: US 2023/0142098 A1
(43) Pub. Date: May 11, 2023

(54) LIGHT CONDUCTOR FOR VEHICLE LIGHT, FULL BEAM ILLUMINATION MODULE, AND VEHICLE LIGHT

(71) Applicant: HASCO VISION TECHNOLOGY CO., LTD., Shanghai (CN)

(72) Inventor: Jie ZHANG, Shanghai (CN)

(21) Appl. No.: 17/919,798

(22) PCT Filed: Mar. 2, 2021
(86) PCT No.: PCT/CN2021/078647

§ 371 Date: Oct. 19, 2022

(30) Foreign Application Priority Data
Apr. 30, 2020 (CN) 202010367193.X
Jun. 23, 2020 (CN) 202010584682.0

(51) Int. Cl. F21S 41/663; F21S 45/47; F21S 41/151; F21S 41/27; F21S 41/143

(52) U.S. Cl. CPC F21S 41/663; F21S 45/47; F21S 41/151; F21S 41/27; F21S 41/143

(57) ABSTRACT

A light conductor (1) for a vehicle light, comprising a light entrance part (11) and a light exit part (12), the light entrance part (11) being provided with a first single orientation alignment plane (13), the light exit part (12) being provided with a second single orientation alignment plane (14), and the alignment orientation of the first single orientation alignment plane (13) being perpendicular to the alignment orientation of the second single orientation alignment plane (14). The light rays emitted by a light source arranged at the light entrance part (11) can thus be formed into a light spot with bright and dark boundaries and having the required shape. Also disclosed is a full beam illumination module, comprising a plurality of light-emitting chips (2), a circuit board (3), a heat sink (4), and the light conductor (1) for a vehicle light, and capable of forming an illumination light shape composed of a plurality of light spots with bright and dark boundaries.

### CROSS-REFERENCE TO RELATED APPLICATIONS

The present application claims benefits of Chinese Patent Application No. 202010367193.X, filed on Apr. 30, 2020 and Chinese Patent Application No. 202010584682.0, filed on Jun. 23, 2020, the contents of which are incorporated herein by reference.

### TECHNICAL FIELD

The present disclosure relates to a vehicle light, and particularly to a light conductor for a vehicle light. The present disclosure further relates to a full beam (i.e., driving beam or high beam) illumination module and a vehicle light.

### BACKGROUND ART

The adaptive driving beam (ADB) illumination function means that local illumination dark regions are realized using dynamic control signals, so as to avoid safety risks caused when full beam illumination dazzles drivers of other vehicles on the road surface. Meanwhile, as many illumination light rays as possible can be provided for a driver of a host vehicle to form a better driving environment.

In most full beam illumination modules with the adaptive driving beam function, a plurality of independently controllable light sources arranged in a matrix realize adjacent illumination light spots with a number corresponding to the number of the light sources in conjunction with a primary optical unit and a secondary optical unit. Light entrance surfaces and light exit surfaces of existing secondary optical units are mostly spherical surfaces, the illumination light spot formed by each independently controllable light source has a similar shape to the light source, and an illumination light spot with a required specific shape and a bright and dark boundary is difficult to form. An illumination light shape is usually formed by intersecting and mixing the illumination light spots, and a clear illumination dark region with an illumination boundary is difficult to form.

In some other full beam illumination modules with the adaptive driving beam function, in order to form an illumination dark region with a clear boundary and a specific shape, a cylindrical-surface optical unit is additionally arranged between the primary optical unit and the secondary optical unit, and the diffusion of an illumination light spot in the direction perpendicular to the cylindrical surface axis is controlled by the cylindrical-surface optical unit to form an illumination light spot with a required specific shape and a bright and dark boundary. However, such an arrangement results in a more complex structure of an optical system, the illumination light efficiency is reduced, and the optical performance of the full beam illumination module is greatly influenced by manufacturing errors of various parts. Moreover, the size of a product is correspondingly increased, and the requirement for the assembly precision is higher.

### SUMMARY

The technical problem to be solved by the present disclosure is to provide a light conductor for a vehicle light, which can form light rays emitted by a light-emitting chip into an illumination light spot with a required shape and a bright and dark boundary.

The further technical problem to be solved by the present disclosure is to provide a full beam illumination module which can form an illumination light shape composed of a plurality of illumination light spots with bright and dark boundaries with a relatively simple structure.

In addition, the technical problem to be solved by the present disclosure is to provide a vehicle light.

In order to solve the above technical problems, an aspect of the present disclosure provides a light conductor for a vehicle light, including a light entrance part and a light exit part, the light entrance part being provided with a first single orientation collimating plane, the light exit part being provided with a second single orientation collimating plane, and the collimating orientation of the first single orientation collimating plane being perpendicular to the collimating orientation of the second single orientation collimating plane.

Preferably, the collimating orientation of the first single orientation collimating plane is a vertical orientation, and the collimating orientation of the second single orientation collimating plane is a horizontal orientation. In this preferred technical solution, entrance light rays are first collimated in the vertical orientation by the first single orientation collimating plane and then collimated in the horizontal orientation by the second single orientation collimating plane of the light conductor for a vehicle light, and then form an illumination light spot with a bright and dark boundary, and the illumination light spot is diffused to different degrees in the vertical orientation and the horizontal orientation.

Preferably, the first single orientation collimating plane is a quasi-parabolic cylindrical surface with a horizontal cylindrical surface axis. In this preferred technical solution, the quasi-parabolic cylindrical surface with a horizontal cylindrical surface axis can achieve a good single orientation collimating effect in the vertical orientation, and is convenient to process.

Further, the light entrance part is formed into a light converging cup-shaped structure, and the first single orientation collimating plane is formed at the light entrance end of the light converging cup-shaped structure. In this preferred technical solution, the light converging cup-shaped structure not only can better receive and collimate the entrance light rays to achieve a high light efficiency, but also helps location between light sources and the light conductor for a vehicle light, and can also reduce the weight of the light conductor for a vehicle light.

Preferably, the first single orientation collimating plane is a horizontal Fresnel cylindrical surface. In this preferred technical solution, the horizontal Fresnel cylindrical surface is a curved surface which is formed according to the principle of a Fresnel lens and has the effect of a cylindrical surface with a horizontal cylindrical surface axis, which achieves the effect of a cylindrical surface, and reduces the convexity of the first single orientation collimating plane, thus reducing the thickness and weight of the light conductor for a vehicle light.

Preferably, the second single orientation collimating plane is a cylindrical surface with a vertical cylindrical surface axis. In this preferred technical solution, the cylindrical surface with the vertical cylindrical surface axis can achieve a single orientation collimating effect in the horizontal orientation, and is easy to process and image.

Preferably, the second single orientation collimating plane is a vertical Fresnel cylindrical surface. In this preferred technical solution, the vertical Fresnel cylindrical surface is a curved surface which is formed according to the principle of a Fresnel lens and has the effect of a cylindrical surface with a vertical cylindrical surface axis, which reduces the convexity of the second single orientation collimating plane while achieving the effect of a cylindrical surface with a vertical cylindrical surface axis, thus reducing the thickness and weight of the light conductor for a vehicle light.

Preferably, a plurality of first single orientation collimating planes are provided, and the plurality of first single orientation collimating planes are vertically arranged in the light entrance part. With this preferred technical solution, each first single orientation collimating plane can correspond to one set of light sources, so as to form an illumination light shape formed by the light rays emitted by the plural sets of light sources.

A second aspect of the present disclosure provides a full beam illumination module, including light-emitting chips, a circuit board, a heat sink and the light conductor for a vehicle light according to the first aspect of the present disclosure, wherein a plurality of light-emitting chips are provided, the plurality of light-emitting chips can be independently controlled to be turned on or off, the plurality of light-emitting chips are mounted on the circuit board, the circuit board is mounted on the heat sink, and the light conductor for a vehicle light is provided on light-emitting paths of the light-emitting chips, such that the light-emitting chips are located in the region of the first single orientation collimating plane.

Preferably, the plurality of light-emitting chips are horizontally arranged on the circuit board and all located in the region of the first single orientation collimating plane. In this preferred technical solution, the light rays emitted by the plurality of horizontally arranged light-emitting chips more easily form a plurality of horizontally arranged illumination light spots with bright and dark boundaries under the action of the light conductor for a vehicle light, and the plurality of illumination light spots are combined into a full beam illumination light shape.

Preferably, the above-mentioned light conductor for a vehicle light with a plurality of first single orientation collimating planes is adopted in the full beam illumination module, the plurality of light-emitting chips are provided on the circuit board in a plurality of rows arranged in an array, light-emitting chips in each row are horizontally arranged on the circuit board, individual rows of light-emitting chips are arranged in the vertical direction and form a horizontal offset with a certain distance, and each row of light-emitting chips are located in the focal line region of one first single orientation collimating plane. With this preferred technical solution, the light rays emitted by each set of light-emitting chips can be collimated by the first single orientation collimating plane and refracted by the second single orientation collimating plane, so as to form an illumination region formed by combining the plurality of illumination light spots with bright and dark boundaries, the illumination regions formed by all the sets of light-emitting chips are combined to form the full beam illumination light shape composed of the plurality of illumination light spots arranged in an array, and the control over the single light-emitting chips facilitates the formation of the adaptive driving beam illumination light shape with more accurate control regions.

Preferably, the full beam illumination module according to the present disclosure further includes a lens, and the lens is provided on a light exit path of the light conductor for a vehicle light to project the light rays emitted by the light conductor for a vehicle light, so as to form the illumination light shape. In this preferred technical solution, the arranged lens can secondarily collimate and adjust the light rays emitted by the light conductor for a vehicle light, so as to form a clearer illumination light shape meeting design requirements. The requirement for the collimating performance of the single orientation collimating planes of the light conductor for a vehicle light can be reduced, and thus the size of the light conductor for a vehicle light can be reduced.

A third aspect of the present disclosure provides a vehicle light, including the full beam illumination module according to the second aspect of the present disclosure.

With the above-mentioned technical solution, in the light conductor for a vehicle light according to present disclosure, the first single orientation collimating plane and the second single orientation collimating plane which have perpendicular collimating orientations are arranged at the light entrance part and the light exit part respectively, such that the light rays emitted by the light sources can be collimated to different degrees from the two perpendicular orientations, so as to form the illumination light spots which have different illumination ranges in the two perpendicular orientations and have bright and dark boundaries. Due to the independent arrangement of the first single orientation collimating plane and the second single orientation collimating plane, the boundaries of the illumination light spots in the two perpendicular orientations can be freely designed to form the illumination light spots with different shapes. The defect that an existing light conductor for a vehicle light can only form light spots with bright and dark boundaries in the same shape as a light source or cannot form the bright and dark boundaries of the light spots is overcome, such that the performance and application range of the light conductor for a vehicle light are expanded. In the full beam illumination module according to the present disclosure, the illumination light shape composed of the plurality of illumination light spots with bright and dark boundaries is formed by arranging the plurality of light-emitting chips which can independently controlled to be turned on or off on the first single orientation collimating plane of the light conductor for a vehicle light according to the present disclosure, such that the adaptive driving beam illumination light shape with the illumination region or the illumination dark region having clear boundaries can be formed by independently controlling the plurality of illumination light spots. The full beam illumination module has the advantages of simple structure and clear dark region boundaries. The vehicle light according to the present disclosure also has the above-mentioned advantages due to the use of the full beam illumination module according to the present disclosure.

Other technical features and technical effects of the present disclosure will be further described in the following specific embodiments.

### BRIEF DESCRIPTION OF DRAWINGS

FIG. 1 is a side view of a light conductor for a vehicle light according to an embodiment of the present disclosure;

FIG. 2 is a top view of the light conductor for a vehicle light shown in FIG. 1;

FIG. 3 is a rear view of the light conductor for a vehicle light shown in FIG. 1;

FIG. 4 is a side view of a light conductor for a vehicle light according to another embodiment of the present disclosure;

FIG. 5 is a top view of the light conductor for a vehicle light shown in FIG. 4;

FIG. 6 is a rear view of the light conductor for a vehicle light shown in FIG. 4;

FIG. 7 is a side view of a light conductor for a vehicle light according to still another embodiment of the present disclosure;

FIG. 8 is a top view of the light conductor for a vehicle light shown in FIG. 7;

FIG. 9 is a rear view of the light conductor for a vehicle light shown in FIG. 7;

FIG. 10 is a partial enlarged view of portion A in FIG. 7;

FIG. 11 is a side view of a light conductor for a vehicle light according to still another embodiment of the present disclosure;

FIG. 12 is a front view of the light conductor for a vehicle light shown in FIG. 11;

FIG. 13 is a sectional view taken at position B-B in FIG. 12;

FIG. 14 is a partial enlarged view of portion C in FIG. 13;

FIG. 15 is a front view of a full beam illumination module according to an embodiment of the present disclosure;

FIG. 16 is a left view of the full beam illumination module shown in FIG. 15;

FIG. 17 is a top view of the full beam illumination module shown in FIG. 15;

FIG. 18 is a schematic sectional diagram of the full beam illumination module shown in FIG. 15;

FIG. 19 is a schematic diagram of a vertical light path of the full beam illumination module shown in FIG. 15;

FIG. 20 is a schematic diagram of a horizontal light path of the full beam illumination module shown in FIG. 15;

FIG. 21 is a schematic diagram of a light path of a full beam illumination module according to another embodiment of the present disclosure;

FIG. 22 is a schematic diagram of a light path of a full beam illumination module according to still another embodiment of the present disclosure;

FIG. 23 is a partial enlarged view of portion D in FIG. 22;

FIG. 24 is a schematic partial structural diagram of a full beam illumination module according to still another embodiment of the present disclosure;

FIG. 25 is a schematic diagram of an illumination light spot formed by the full beam illumination module according to the present disclosure;

FIG. 26 is a schematic diagram of an illumination light shape formed by the full beam illumination module according to the present disclosure;

FIG. 27 is a schematic diagram of an adaptive driving beam light shape formed by the full beam illumination module according to the present disclosure;

FIG. 28 is a schematic diagram of another illumination light shape formed by the full beam illumination module according to the present disclosure;

FIG. 29 is a front view of a full beam illumination module according to still another embodiment of the present disclosure;

FIG. 30 is a left view of the full beam illumination module shown in FIG. 29; and

FIG. 31 is a top view of the full beam illumination module shown in FIG. 29.

Reference numerals

| | | | |
|---|---|---|---|
| 1 | light conductor for vehicle light | 11 | light entrance part |
| 12 | light exit part | 13 | first single orientation |
| | | | collimating plane |
| 14 | second single orientation | 15 | parabolic cylindrical surface |
| | collimating plane | | |
| 16 | light inlet transition surface | 2 | light-emitting chip |
| 3 | circuit board | 4 | heat sink |
| 5 | lens | | |

### DETAILED DESCRIPTION OF EMBODIMENTS

In the present disclosure, unless otherwise stated, the orientation or positional relationship indicated by the use of the orientation words, such as “front, rear, upper, lower, horizontal, vertical”, is the orientation or positional relationship after a vehicle light according to the present disclosure is normally mounted on a vehicle. The direction indicated by the orientation word “front” is the normal driving direction of the vehicle; the direction indicated by the orientation word “vertical” is the direction perpendicular to the horizontal plane. The description of the orientation or positional relationship of a light conductor for a vehicle light, a full beam illumination module and its components according to the present disclosure is consistent with the mounting orientation thereof in actual use.

The specific embodiments of the present disclosure will be described in detail below with reference to the accompanying drawings. It should be understood that the specific embodiments described herein are only used to illustrate and explain the present disclosure, and the protection scope of the present disclosure is not limited to the following specific embodiments.

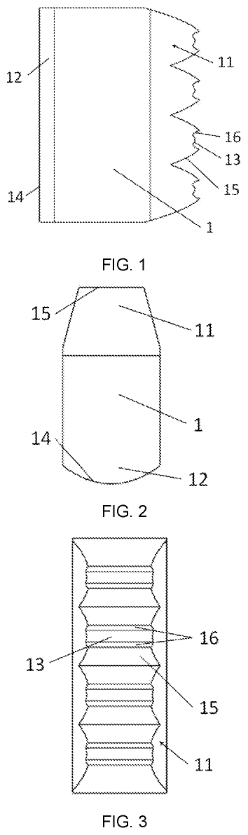

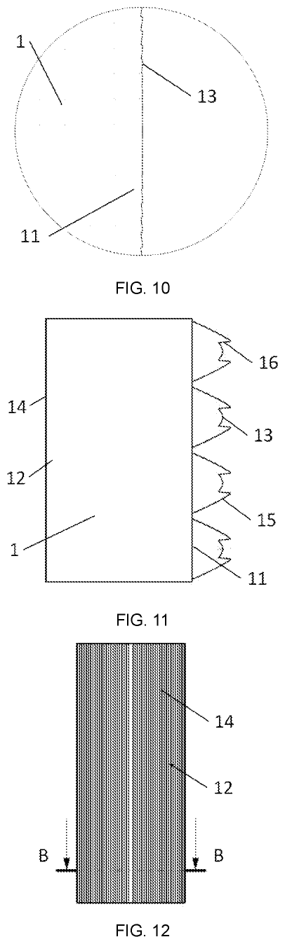

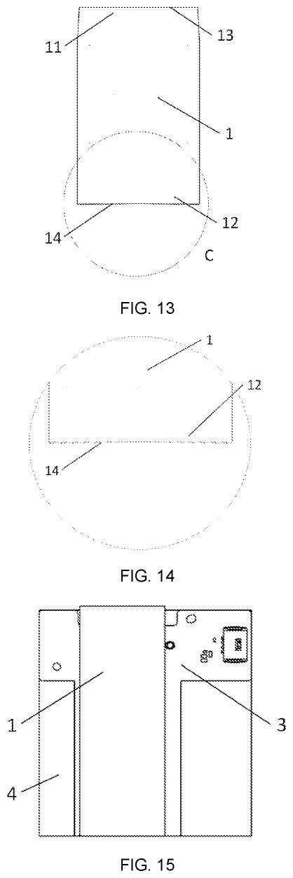

As shown in FIGS. 1 to 14, a light conductor 1 for a vehicle light according to an embodiment of the present disclosure includes a light entrance part 11 and a light exit part 12. A first single orientation collimating plane 13 is formed on the light entrance part 11, and a second single orientation collimating plane 14 is formed on the light exit part 12. Usually, a single orientation collimating plane is a curved surface formed by moving a curve along a straight line direction, and the moving curve, i.e., a generatrix of the curved surface, can be a circular arc, an elliptic arc, a parabola, a free curve, or the like. The straight line for the curvilinear motion is called a guide line of the curved surface; the plane formed by moving the connecting line of the two end points of the curve along the straight line direction is called a base plane of the single orientation collimating plane; the locus formed by moving the middle point of the connecting line of the two end points of the curve along the straight line direction is called an axis of the single orientation collimating plane or a cylindrical surface axis. When light rays illuminate the single orientation collimating plane in the direction perpendicular to the base plane of the single orientation collimating plane, the light rays on a certain orientation line (the orientation of the guide line of the single orientation collimating plane) of the base plane are not converged in any form, and the light rays on the other orientation line (the orientation of the generatrix of the single orientation collimating plane) can be converged to the greatest degree. Generally, the orientation line without any form of convergence is perpendicular to the orientation line with the greatest degree of convergence. Herein, the orientation indicated by the orientation line forming the greatest degree of convergence is called a collimating orientation of the single orientation collimating plane. In the present disclosure, “orientation” refers to a set of parallel directions. On the light conductor 1 for a vehicle light, the collimating orientation of the first single orientation collimating plane 13 may be perpendicular to the collimating orientation of the second single orientation collimating plane 14. Thus, when the light rays pass through the first single orientation collimating plane 13, a collimating effect may be generated in the collimating orientation of the first single orientation collimating plane 13, and an illumination light spot formed by the light rays is diffused in the collimating orientation of the first single orientation collimating plane 13. When the light rays pass through the second single orientation collimating plane 14, a collimating effect may be generated in the collimating orientation of the second single orientation collimating plane 14, and an illumination light spot formed by the light rays is diffused in the collimating orientation of the second single orientation collimating plane 14. Since the convergence capability in the collimating orientation of the first single orientation collimating plane 13 is different from that of the second single orientation collimating plane 14, the diffusion angle of the illumination light spot formed by the light rays in the collimating orientation of the first single orientation collimating plane 13 is different from the diffusion angle of the illumination light spot in the collimating orientation of the second single orientation collimating plane 14, thus forming the illumination light spots having bright and dark boundaries and different lengths in the collimating orientations of the first single orientation collimating plane 13 and the second single orientation collimating plane 14. By controlling the convergence capabilities in the collimating orientations of the first single orientation collimating plane 13 and the second single orientation collimating plane 14, the diffusion angles of the illumination light spot in the two perpendicular orientations can be controlled, thus controlling the shape of the illumination light spot.

In some embodiments of the light conductor 1 for a vehicle light according to the present disclosure, as shown in FIGS. 1 to 14, the collimating orientation of the first single orientation collimating plane 13 is a vertical orientation, and when the light rays pass through the first single orientation collimating plane 13, an illumination light spot having a bright and dark boundary in the vertical orientation is formed. The collimating orientation of the second single orientation collimating plane 14 is a horizontal orientation, and when the light rays pass through the second single orientation collimating plane 14, an illumination light spot having a bright and dark boundary in the horizontal orientation is formed. Thus, after passing through the light conductor 1 for a vehicle light according to the present disclosure, the light rays can form a rectangular light spot having a straight boundary.

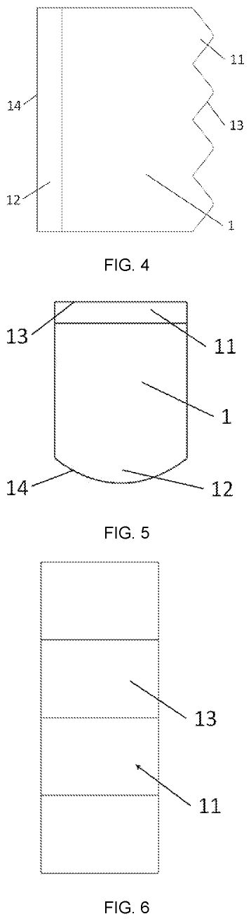

As a specific embodiment of the light conductor 1 for a vehicle light according to the present disclosure, as shown in FIGS. 4 to 6, the first single orientation collimating plane 13 is a quasi-parabolic cylindrical surface with a horizontal cylindrical surface axis. The quasi-parabolic cylindrical surface is a curved surface formed by moving a quasi-parabola with a horizontal symmetry axis on a vertical plane along a horizontal direction perpendicular to the symmetry axis thereof. The quasi-parabola is formed by performing adaptive adjustment on the basis of a parabola. The first single orientation collimating plane 13 in the quasi-parabolic cylindrical surface shape can collimate the incident light rays in the vertical direction, has a good collimating effect, and is convenient to process. Collimating refers to the process that diffused light rays are refracted by a curved surface to be propagated in a nearly parallel direction.

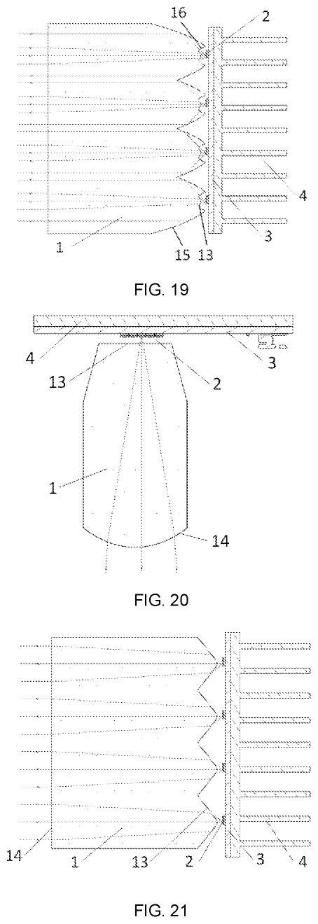

As a specific embodiment of the light conductor 1 for a vehicle light according to the present disclosure, as shown in FIGS. 1 and 3, the light entrance part 11 is formed into a light converging cup-shaped structure which is a parabolic cylinder formed by moving a parabola with a horizontal symmetry axis on a vertical plane in a horizontal direction perpendicular to the symmetry axis thereof. Upper and lower curved surfaces of the parabolic cylinder are formed into a parabolic cylindrical surface 15, and a groove-shaped light inlet is formed in the top end, i.e., the light entrance end, of the parabolic cylinder. The bottom of the light inlet is formed as the first single orientation collimating plane 13, and a light inlet transition surface 16 is formed between the periphery of the first single orientation collimating plane 13 and an opening of the light inlet. As shown in FIG. 19, when the light rays are incident from the light inlet, most light rays are incident on the first single orientation collimating plane 13, collimated by the first single orientation collimating plane 13 and then emitted to the light exit part 12. A small part of light rays are emitted to the light inlet transition surface 16, refracted by the light inlet transition surface 16, then emitted to the parabolic cylindrical surface 15, and totally reflected by the parabolic cylindrical surface 15 to form reflected and collimated light rays which are emitted to the light exit part 12. The arrangement of the light converging cup structure enables the light conductor 1 for a vehicle light to receive more light rays emitted by a light source, and facilitates location between the first single orientation collimating plane 13 and the light source. Meanwhile, unnecessary materials outside a light divergence path can be saved, and thus the weight of the light conductor 1 for a vehicle light can be reduced.

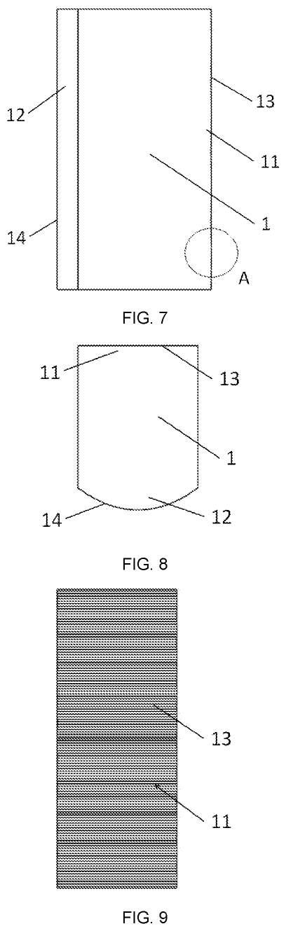

As a specific embodiment of the light conductor 1 for a vehicle light according to the present disclosure, as shown in FIGS. 7 to 10, the first single orientation collimating plane 13 is a horizontal Fresnel cylindrical surface. The horizontal Fresnel cylindrical surface is a curved surface formed by moving, in a horizontal direction perpendicular to the optical axis of a Fresnel lens, an intersection line of a vertical plane passing through the optical axis of the Fresnel lens and a surface of the Fresnel lens with a plurality of concentric circles. The result formed after the light rays are emitted to and refracted by the horizontal Fresnel cylindrical surface is equivalent to the result formed after the light rays are emitted to and refracted by the cylindrical surface with a horizontal cylindrical surface axis. Thus, the refraction effect of a cylindrical surface can be achieved by a substantially planar structure, and the size and weight of the light conductor 1 for a vehicle light can be reduced.

In some embodiments of the light conductor 1 for a vehicle light according to the present disclosure, as shown in FIGS. 1, 2, 4, 5, 7, and 8, the second single orientation collimating plane 14 is a cylindrical surface with a vertical cylindrical surface axis. Similarly, the cylindrical second single orientation collimating plane 14 can form an expanded illumination region with uniform illuminance in the horizontal direction, and also has the advantages of simple structure and convenient processing.

As a specific embodiment of the light conductor 1 for a vehicle light according to the present disclosure, as shown in FIGS. 12 to 14, the second single orientation collimating plane 14 is a vertical Fresnel cylindrical surface. The vertical Fresnel cylindrical surface is a curved surface formed by moving, in a vertical direction perpendicular to the optical axis of a Fresnel lens, an intersection line of a horizontal plane passing through the optical axis of the Fresnel lens and a surface of the Fresnel lens with a plurality of concentric circles. The result formed after the light rays are emitted to and refracted by the vertical Fresnel cylindrical surface is equivalent to the result formed after the light rays are emitted to and refracted by the cylindrical surface with a vertical cylindrical surface axis.

In some embodiments of the light conductor 1 for a vehicle light according to the present disclosure, as shown in FIGS. 1, 3, 4, 6, 9 and 11, the light entrance part 11 is provided with a plurality of first single orientation collimating planes 13, and the first single orientation collimating planes 13 are vertically arranged on the light entrance part 11 to form a plurality of independent surfaces for receiving incident light rays. The collimating orientation of each first single orientation collimating plane 13 is a vertical orientation.

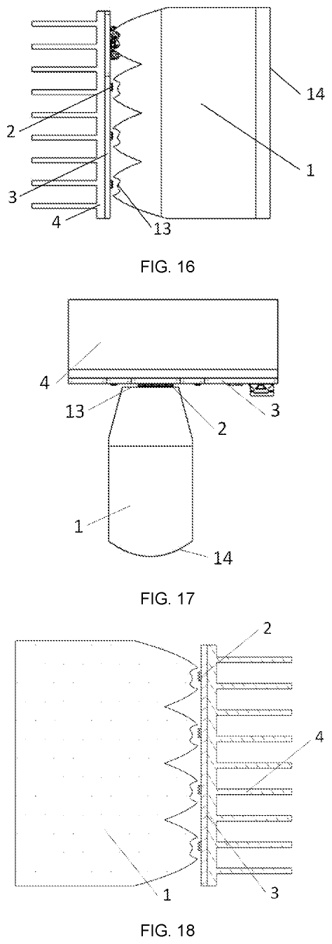

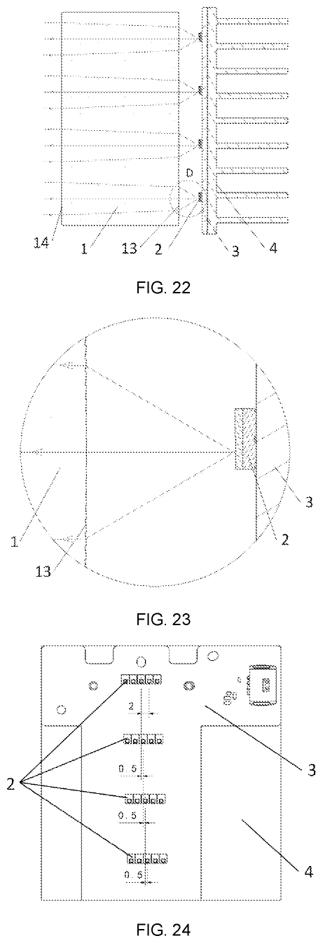

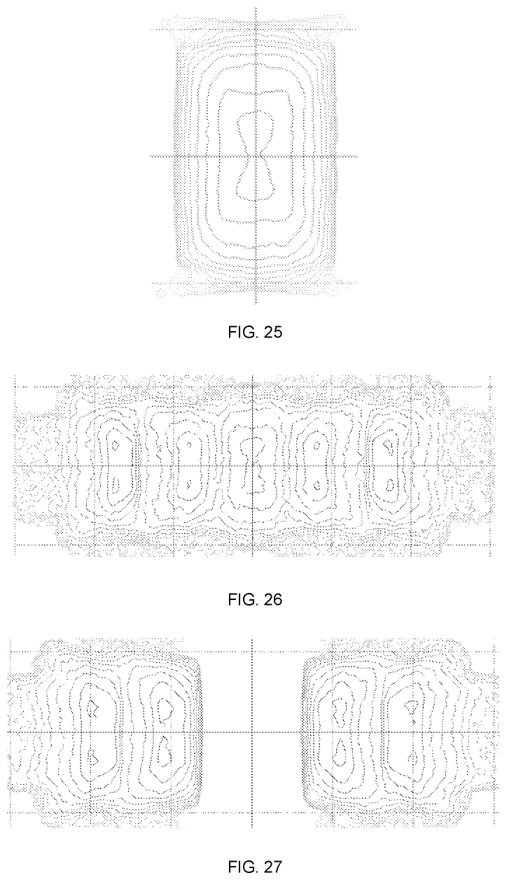

As shown in FIGS. 15 to 24, a full beam illumination module according to an embodiment of the present disclosure includes light-emitting chips 2, a circuit board 3, a heat sink 4, and the light conductor 1 for a vehicle light according to any one of the above-mentioned embodiments. Plural light-emitting chips 2 are provided and may be LED chips or laser chips with square light emitting boundaries, which can be independently controlled to be turned on or off. The light-emitting chip 2 is mounted on the circuit board 3 with the square light emitting boundary in a horizontal or vertical orientation, and power required for the light-emitting chip 2 to emit light is supplied by the circuit board 3. The circuit board 3 is mounted on the heat sink 4, and can transfer the heat generated by the light-emitting chip 2 emitting light to the heat sink 4, so as to reduce the temperature of the light-emitting chip 2 and prevent damage to the light-emitting chip 2 caused by a high temperature. The light conductor 1 for a vehicle light is provided in front of the light emitting surface of the light-emitting chip 2, the light-emitting chips 2 are all located in the region of the first single orientation collimating plane 13 of the light conductor 1 for a vehicle light, and the collimating orientation of the first single orientation collimating plane 13 is parallel to the vertical light emitting boundary of the light-emitting chip 2. The light rays emitted by the light-emitting chip 2 are expanded in both horizontal and vertical orientations by the light conductor 1 for a vehicle light to form a rectangular illumination light spot with a bright and dark boundary as shown in FIG. 25. The plurality of light-emitting chips 2 emit light simultaneously to form an illumination light shape as shown in FIG. 26. By independently controlling the light-emitting chips 2, one or more light-emitting chips 2 can be turned off if necessary, and an illumination dark region having a bright and dark boundary as shown in FIG. 27 is formed in an illumination region corresponding to the light-emitting chip 2, thereby forming an illumination light shape with the illumination dark region capable of achieving an adaptive driving beam function. A plurality of light-emitting chips 2 may be arranged in the region of the same first single orientation collimating plane 13, or the orientations of the base planes of different first single orientation collimating planes 13 are set, for example, the base planes of different first single orientation collimating planes 13 and the light exit surfaces of the corresponding light-emitting chips 2 are disposed at a certain angle, such that the illumination light spots formed by the light-emitting chips 2 in the regions of different first single orientation collimating planes 13 are arranged in parallel. Since the light rays emitted by the light-emitting chip 2 form the illumination light shape only by two refraction surfaces, i.e., the first single orientation collimating plane 13 and the second single orientation collimating plane 14 of the light conductor 1 for a vehicle light, the loss of the light rays at the refraction surfaces is small, and therefore, the illumination light effect is higher.

In some embodiments of the full beam illumination module according to the present disclosure, as shown in FIGS. 17 and 20, the plurality of light-emitting chips 2 are horizontally arranged on the circuit board 3. The plurality of horizontally arranged light-emitting chips 2 are all located in the region of the same first single orientation collimating plane 13. As a preferred embodiment, the first single orientation collimating plane 13 is a curved surface formed by taking a circular arc in a vertical orientation as a generatrix and moving the circular arc in a direction (horizontal direction) perpendicular to a plane where the circular arc is located, the first single orientation collimating plane 13 has a focal line in a horizontal orientation, and the plurality of light-emitting chips 2 are horizontally arranged near the focal line of the first single orientation collimating plane 13. Since the first single orientation collimating plane 13 is formed by a locus of straight line movement of a curve in a horizontal orientation, a plurality of light-emitting chips 2 may be arranged along the straight line direction, and the light rays emitted by the plurality of light-emitting chips 2 and refracted by the first single orientation collimating plane 13 have the same light distribution. Then, the light rays are refracted by the second single orientation collimating plane 14 to form the illumination light shape composed of a plurality of rectangular illumination light spots with similar shapes as shown in FIG. 25. By independently controlling the light-emitting chips 2, one or more light-emitting chips 2 can be turned off if necessary, and an illumination dark region having a bright and dark boundary as shown in FIG. 27 is formed in an illumination region corresponding to the light-emitting chip 2, thereby forming an illumination light shape with the illumination dark region capable of achieving an adaptive driving beam function.

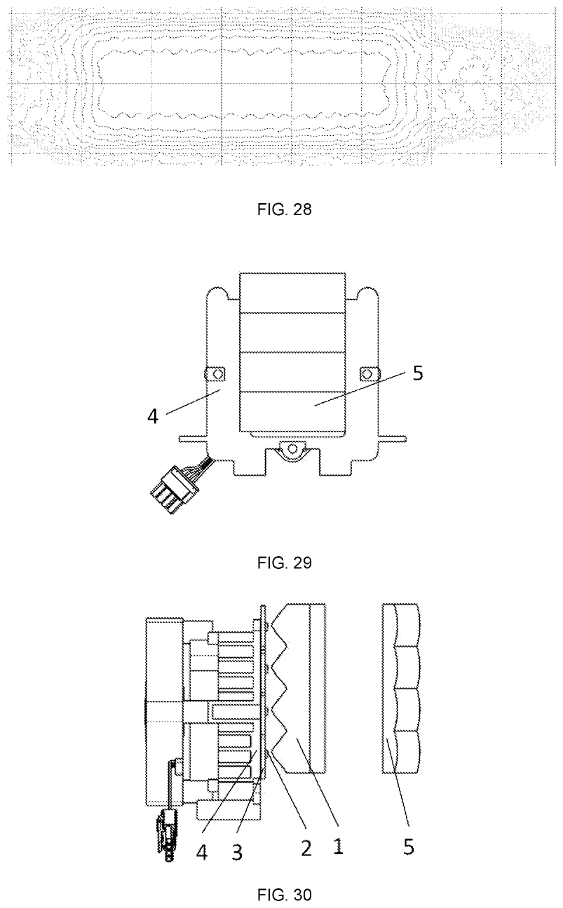

In some embodiments of the full beam illumination module according to the present disclosure, as shown in FIG. 24, the plurality of light-emitting chips 2 are arranged on the circuit board 3 in a plurality of rows arranged in an array, and light-emitting chips 2 in each row are horizontally arranged on the circuit board 3. The numbers of the light-emitting chips 2 included in the rows may be the same or different depending on the designed light shape. The light-emitting chips 2 in different rows are vertically arranged on the circuit board 3, and the light-emitting chips 2 in different rows can be arranged in the same vertical direction or form a horizontal offset with a certain distance on the basis of the vertical arrangement. Correspondingly, the light conductor 1 for a vehicle light is the light conductor 1 for a vehicle light according to the embodiment with a plurality of first single orientation collimating planes 13, each first single orientation collimating plane 13 corresponds to one row of light-emitting chips 2, and the light-emitting chips 2 in each row are located near the focal line of the corresponding first single orientation collimating plane 13. The light conductor 1 for a vehicle light can form a rectangular illumination light spot by the light rays emitted by each light-emitting chip 2 in the row, and the illumination light spots formed by the light-emitting chips 2 in the row are adjacently arranged in the horizontal direction; the illumination light spots formed by the rows of light-emitting chips 2 are arranged adjacently or partially overlapped in the vertical direction to form a full beam illumination light shape composed of a plurality of independent rectangular illumination light spots as shown in FIG. 28. In a specific embodiment, a total of 20 square LED light-emitting chips 2 are arranged on the circuit board 3, and each light-emitting chip 2 has a side length of 2 millimeters. The 20 light-emitting chips 2 are arranged on the circuit board 3 in 4 rows, each row is composed of 5 light-emitting chips 2 which are horizontally arranged, the distance between the centers of the adjacent light-emitting chips 2 in each row is 2 millimeters, individual rows of light-emitting chips 2 are vertically arranged on the circuit board 3, and every two adjacent rows of light-emitting chips have a horizontal offset of 0.5 millimeters. The light conductor 1 for a vehicle light has 4 first single orientation collimating planes 13 and 1 second single orientation collimating plane 14, each row of light-emitting chips 2 correspond to one first single orientation collimating plane 13, and the light rays emitted by the rows of light-emitting chips 2 are incident from different first single orientation collimating planes 13 and emitted out through one second single orientation collimating plane 14. Since a large number of light-emitting chips 2 are adopted, the number of the illumination light spots forming the illumination light shape is also large, the position of the illumination dark region formed in the illumination light shape is also more precise by independently controlling the light-emitting chips 2, and meanwhile, turn-off of one light-emitting chip 2 has smaller influence on the brightness of the illumination light shape, and the dark region effect and the illumination effect of a formed adaptive driving beam are both better.

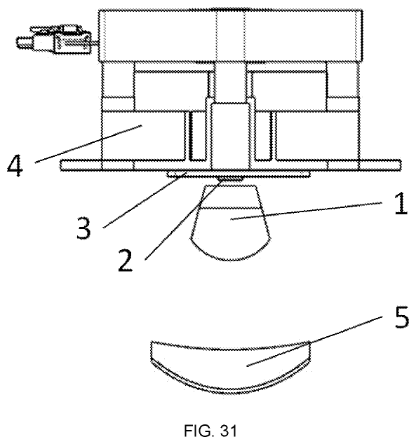

In some embodiments of the full beam illumination module according to the present disclosure, as shown in FIGS. 29 to 31, the full beam illumination module according to the present disclosure is further provided with a lens 5. The lens 5 is provided on a light exit path of the light conductor 1 for a vehicle light, and can further converge and project the light rays emitted from the light conductor 1 for a vehicle light to form the desired illumination light shape. The lens 5 may be a convex lens with a concave incident surface, a plano-convex lens or a biconvex lens, or a convex lens having a cylindrical surface refraction effect in a certain orientation. The lens 5 may be formed into a convex lens structure as a whole, or convex lenses with the number consistent with the number of the first single orientation collimating planes 13 of the light conductor 1 for a vehicle light are combined into a lens structure. The lens 5 can perform overall projection or secondary collimating adjustment on the illumination light shape emitted by the light-emitting chips 2 and formed by the light conductor 1 for a vehicle light, so as to optimize the formed illumination light shape.

With the above technical solution, in the light conductor for a vehicle light according to the present disclosure, the first single orientation collimating plane is provided at the light entrance part, and the second single orientation collimating plane is provided at the light exit part, such that the light rays emitted by the light source can be collimated in two perpendicular collimating orientations, and the illumination light spots formed by the light rays emitted by the light source have different diffusion angles in the two perpendicular orientations, thus forming the illumination light spots with required specific shapes and bright and dark boundaries. In the full beam illumination module according to the present disclosure, the plurality of light-emitting chips which can be independently controlled to be turned on or off and the light conductor for a vehicle light according to the present disclosure are adopted, the illumination light spots formed by the plurality of light-emitting chips can be combined to form the full beam illumination light shape formed by combining the plurality of independent illumination light spots with bright and dark boundaries. By the independent control over the light-emitting chips, the illumination dark region with a bright and dark boundary can be formed at the appointed position of the illumination light shape, so as to achieve the adaptive driving beam illumination function. Since the formed dark region has the bright and dark boundary, no stray light exists in the dark region, the illumination brightness outside the dark region is high, and therefore, the shielding effect on opposite targets is better, the illumination effect on peripheral regions of the target is better, and the use safety is higher. In addition, since the collimating function in two perpendicular directions is achieved by a single part in the light conductor for a vehicle light according to the present disclosure, it is possible to realize higher manufacturing precision and higher positioning precision of the part. The stability of the position of the illumination light spot formed by the light-emitting chip is guaranteed, and a more stable illumination light shape can be formed.

The vehicle light according to the present disclosure has the above beneficial effects of the full beam illumination module according to the present disclosure due to the adoption of the full beam illumination module according to the present disclosure.

In the description of the present disclosure, reference to terms “an embodiment”, “some embodiments”, “a specific embodiment”, or the like, means that a particular feature, structure, material, or characteristic described in connection with the embodiment or example is included in at least one embodiment or example of the present disclosure. In the present disclosure, the schematic expressions to the above-mentioned terms are not necessarily referring to the same embodiment or example. Furthermore, the described particular features, structures, materials, or characteristics may be combined in any suitable manner in one or more embodiments or examples.

The preferred embodiments of the present disclosure have been described in detail above with reference to the accompanying drawings, but the present disclosure is not limited thereto. Within the scope of the technical concept of the present disclosure, numerous simple modifications can be made to the technical solution of the present disclosure, including any suitable combination of specific technical features, and in order to avoid unnecessary repetition, various possible combinations will not be described in the present disclosure. Such simple modifications and combinations should also be regarded as the contents disclosed in the present disclosure, and all belong to the protection scope of the present disclosure.

1. A light conductor for a vehicle light, comprising: a light entrance part and a light exit part, wherein the light entrance part is provided with a first single orientation collimating plane, the light exit part is provided with a second single orientation collimating plane, and a collimating orientation of the first single orientation collimating plane is perpendicular to a collimating orientation of the second single orientation collimating plane.

2. The light conductor for a vehicle light according to claim 1, wherein the collimating orientation of the first single orientation collimating plane is a vertical orientation, and the collimating orientation of the second single orientation collimating plane is a horizontal orientation.

3. The light conductor for a vehicle light according to claim 2, wherein the first single orientation collimating plane is a quasi-parabolic cylindrical surface with a horizontal cylindrical surface axis.

4. The light conductor for a vehicle light according to claim 2, wherein the light entrance part is formed into a light converging cup-shaped structure, and the first single orientation collimating plane is formed at a light entrance end of the light converging cup-shaped structure.

5. The light conductor for a vehicle light according to claim 2, wherein the first single orientation collimating plane is a horizontal Fresnel cylindrical surface.

6. The light conductor for a vehicle light according to claim 2, wherein the second single orientation collimating plane is a cylindrical surface with a vertical cylindrical surface axis.

7. The light conductor for a vehicle light according to claim 2, wherein the second single orientation collimating plane is a vertical Fresnel cylindrical surface.

8. The light conductor for a vehicle light according to claim 2, wherein a plurality of first single orientation collimating planes are provided, and the plurality of first single orientation collimating planes are vertically arranged in the light entrance part.

9. A full beam illumination module, comprising: light-emitting chips, a circuit board, a heat sink and the light conductor for a vehicle light according to claim 2, wherein a plurality of light-emitting chips are provided, the plurality of light-emitting chips can be independently controlled to be turned on or off, the plurality of light-emitting chips are mounted on the circuit board, the circuit board is mounted on the heat sink, and the light conductor for a vehicle light is provided on light-emitting paths of the light-emitting chips, such that the light-emitting chips are located in a region of the first single orientation collimating plane.

10. The full beam illumination module according to claim 9, wherein the plurality of light-emitting chips are horizontally arranged on the circuit board and all located in the region of the first single orientation collimating plane.

11. The full beam illumination module according to claim 9, wherein the light conductor for a vehicle light according to claim 8 is adopted in the full beam illumination module, the plurality of light-emitting chips are provided on the circuit board in a plurality of rows arranged in an array, light-emitting chips in each row are horizontally arranged on the circuit board, individual rows of light-emitting chips are arranged in a vertical direction and form a horizontal offset with a certain distance, and each row of light-emitting chips are located in a focal line region of one first single orientation collimating plane.

12. The full beam illumination module according to claim 9, further comprising a lens, wherein the lens is provided on a light exit path of the light conductor for a vehicle light to project light rays emitted by the light conductor for a vehicle light, so as to form an illumination light shape.

13. A vehicle light, comprising the full beam illumination module according to claim 9.

14. The light conductor for a vehicle light according to claim 3, wherein a plurality of first single orientation collimating planes are provided, and the plurality of first single orientation collimating planes are vertically arranged in the light entrance part.

15. The light conductor for a vehicle light according to claim 4, wherein a plurality of first single orientation collimating planes are provided, and the plurality of first single orientation collimating planes are vertically arranged in the light entrance part.

16. The light conductor for a vehicle light according to claim 5, wherein a plurality of first single orientation collimating planes are provided, and the plurality of first single orientation collimating planes are vertically arranged in the light entrance part.

17. The light conductor for a vehicle light according to claim 6, wherein a plurality of first single orientation collimating planes are provided, and the plurality of first single orientation collimating planes are vertically arranged in the light entrance part.

18. The light conductor for a vehicle light according to claim 7, wherein a plurality of first single orientation collimating planes are provided, and the plurality of first single orientation collimating planes are vertically arranged in the light entrance part.

19. The full beam illumination module according to claim 10, further comprising a lens, wherein the lens is provided on a light exit path of the light conductor for a vehicle light to project light rays emitted by the light conductor for a vehicle light, so as to form an illumination light shape.

20. The full beam illumination module according to claim 11, further comprising a lens, wherein the lens is provided on a light exit path of the light conductor for a vehicle light to project light rays emitted by the light conductor for a vehicle light, so as to form an illumination light shape.
